(19) United States
(12) Patent Application Publication
(10) Pub. No.: US 2018/0246964 A1
(43) Pub. Date: Aug. 30, 2018

(54) SPEECH INTERFACE FOR VISION-BASED MONITORING SYSTEM

(71) Applicant: Lighthouse AI, Inc., Palo Alto, CA (US)

(72) Inventors: Alexander William Teichman, Palo Alto, CA (US); Karsten Sperling, Auckland (NZ); Hendrik Dahlkamp, Palo Alto, CA (US); Andreas Ubbe Dall, Hellerup (DK); Andy Griffiths, Auckland (NZ); Miraj Hassanpur, Elk Grove, CA (US)

(73) Assignee: Lighthouse AI, Inc., Palo Alto, CA (US)

(21) Appl. No.: 15/445,501

(22) Filed: Feb. 28, 2017

(51) Int. Cl. G06F 17/30; G10L 15/22; G10L 15/26; G06K 9/00; G06K 9/62; G06F 3/16

(52) U.S. Cl. CPC G06F 17/30787; G10L 15/22; G10L 15/265; G06K 9/00771; G10L 2015/223; G06K 9/00744; G06K 9/6202; G06F 3/167; G06F 17/30867; G06K 9/00718

(57) ABSTRACT

A method for natural language-based interaction with a vision-based monitoring system. The method includes obtaining a request input from a user, by the vision-based monitoring system. The request input is directed to an object detected by a classifier of the vision-based monitoring system. The method further includes obtaining an identifier associated with the request input, identifying a site of the vision-based monitoring system from a plurality of sites, based on the identifier, generating a database query, based on the request input and the identified site, and obtaining, from a monitoring system database, video frames that relate to the database query. The video frames include the detected object. The method also includes providing the video frames to the user.

### BACKGROUND

Monitoring systems may be used to secure environments and, more generally, to track activity in these environments. A monitoring system may provide a variety of functionalities and may include a variety of controllable and configurable options and parameters. These features may greatly benefit from a user-friendly control interface.

### SUMMARY

In general, in one aspect, the invention relates to a method for natural language-based interaction with a vision-based monitoring system. The method includes obtaining a request input from a user, by the vision-based monitoring system. The request input is directed to an object detected by a classifier of the vision-based monitoring system. The method further includes obtaining an identifier associated with the request input, identifying a site of the vision-based monitoring system from a plurality of sites, and based on the identifier, generating a database query, based on the request input and the identified site, and obtaining, from a monitoring system database, video frames that relate to the database query. The video frames include the detected object. The method also includes providing the video frames to the user.

In general, in one aspect, the invention relates to a non-transitory computer readable medium including instructions that enable a system to obtain a request input from a user, by the vision-based monitoring system. The request input is directed to an object detected by a classifier of the vision-based monitoring system. The instructions further enable the system to obtain an identifier associated with the request input, identify a site of the vision-based monitoring system from a plurality of sites, based on the identifier, generate a database query, based on the request input and the identified site, and obtain, from a monitoring system database, video frames that relate to the database query. The video frames include the detected object. The instructions also enable the system to provide the video frames to the user.

### BRIEF DESCRIPTION OF DRAWINGS

FIG. 1 shows an exemplary monitoring system, in accordance with one or more embodiments of the invention.

FIG. 2 shows an exemplary interaction of a user with the monitoring system, using spoken language, in accordance with one or more embodiments of the invention.

FIG. 3 shows an organization of a monitoring system database, in accordance with one or more embodiments of the invention.

FIGS. 4-6 show flowcharts describing methods for speech-based interaction with a vision-based monitoring system, in accordance with one or more embodiments of the invention.

FIG. 7 shows a computing system, in accordance with one or more embodiments of the invention.

### DETAILED DESCRIPTION

Specific embodiments of the invention will now be described in detail with reference to the accompanying figures. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

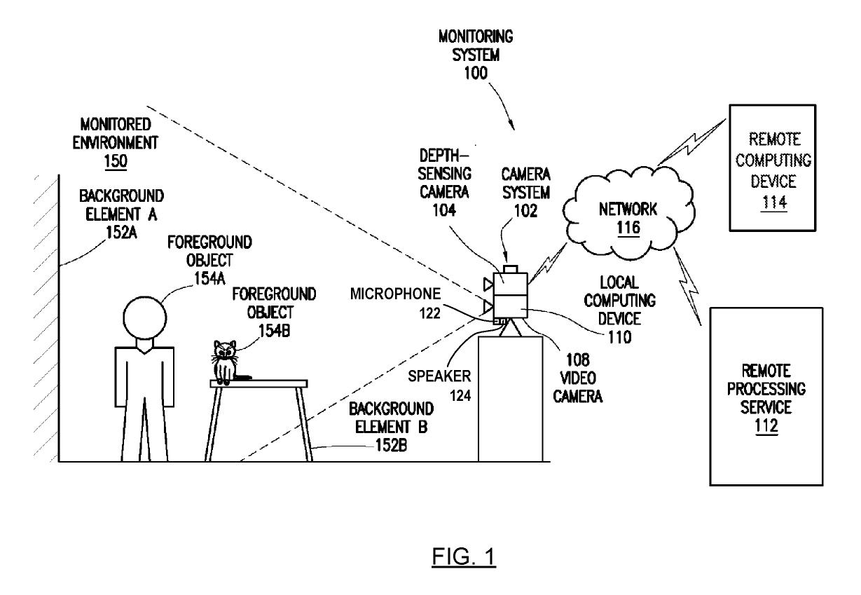

In the following description of FIGS. 1-7, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to a monitoring system used for monitoring and/or securing an environment. More specifically, one or more embodiments of the invention enable speech interaction with the monitoring system for various purposes, including the configuration of the monitoring system and/or the control of functionalities of the monitoring system. In one or more embodiments of the technology, the monitoring system supports spoken language queries, thereby allowing a user to interact with the monitoring system using common language. Consider, for example, a scenario in which a user of the monitoring system returns home after work and wants to know whether the dog-sitter has walked the dog. The owner may ask the monitoring system: “Tell me when the dog sitter was here.” In response, the monitoring system may analyze the activity registered throughout the day and may, for example, reply by providing the time when the dog sitter was last seen by the monitoring system, or it may alternatively or in addition play back a video recorded by the monitoring system when the dog sitter was at the house. Speech interaction may thus be used to request and review activity captured by the monitoring system. Those skilled in the art will recognize that the above-described scenario is merely an example, and that the invention is not limited to this example. A detailed description is provided below.

FIG. 1 shows an exemplary monitoring system (100) used for the surveillance of an environment (monitored environment (150)), in accordance with one or more embodiments of the invention. The monitored environment may be a three-dimensional space that is within the field of view of a camera system (102). The monitored environment (150) may be, for example, an indoor environment, such as a living room or an office, or it may be an outdoor environment such as a backyard. The monitored environment (150) may include background elements (e.g., 152A, 152B) and foreground objects (e.g., 154A, 154B). Background elements may be actual backgrounds, e.g., a wall or walls of a room, and/or other objects, such a furniture.

In one embodiment of the invention, the monitoring system (100) may classify certain objects, e.g., stationary objects such as a table (background element B (152B)) as background elements. Further, in one embodiment of the invention, the monitoring system (100) may classify other objects, e.g., moving objects such as a human or a pet, as foreground objects (154A, 154B). The monitoring system (100) may further classify detected foreground objects (154A, 154B) as threats, for example, if the monitoring system (100) determines that a person (154A) detected in the monitored environment (150) is an intruder, or as harmless, for example, if the monitoring system (100) determines that the person (154A) detected in the monitored environment (150) is the owner of the monitored premises, or if the classified object is a pet (154B). Embodiments of the invention may be based on classification schemes ranging from a mere distinction between moving and non-moving objects to the distinction of many classes of objects, including for example the recognition of particular people and/or the distinction of different pets, without departing from the invention.

In one embodiment of the invention, the monitoring system (100) includes a camera system (102) and a remote processing service (112). In one embodiment of the invention, the monitoring system further includes one or more remote computing devices (114). Each of these components is described below.

The camera system (102) may include a video camera (108) and a local computing device (110), and may further include a depth sensing camera (104). The camera system (102) may be a portable unit that may be positioned such that the field of view of the video camera (108) covers an area of interest in the environment to be monitored. The camera system (102) may be placed, for example, on a shelf in a corner of a room to be monitored, thereby enabling the camera to monitor the space between the camera system (102) and a back wall of the room. Other locations of the camera system may be used without departing from the invention.

The video camera (108) of the camera system (102) may be capable of continuously capturing a two-dimensional video of the environment (150). The video camera may use, for example, an RGB or CMYG color or grayscale CCD or CMOS sensor with a spatial resolution of for example, 320×240 pixels, and a temporal resolution of 30 frames per second (fps). Those skilled in the art will appreciate that the invention is not limited to the aforementioned image sensor technologies, temporal, and/or spatial resolutions. Further, a video camera's frame rates may vary, for example, depending on the lighting situation in the monitored environment.

In one embodiment of the invention, the camera system (102) further includes a depth-sensing camera (104) that may be capable of reporting multiple depth values from the monitored environment (150). For example, the depth-sensing camera (104) may provide depth measurements for a set of 320×240 pixels (Quarter Video Graphics Array (QVGA) resolution) at a temporal resolution of 30 frames per second (fps). The depth-sensing camera (104) may be based on scanner-based or scannerless depth measurement techniques such as, for example, LIDAR, using time-of-flight measurements to determine a distance to an object in the field of view of the depth-sensing camera (104). The field of view and the orientation of the depth sensing camera may be selected to cover a portion of the monitored environment (150) similar (or substantially similar) to the portion of the monitored environment captured by the video camera. In one embodiment of the invention, the depth-sensing camera (104) may further provide a two-dimensional (2D) grayscale image, in addition to the depth-measurements, thereby providing a complete three-dimensional (3D) grayscale description of the monitored environment (150). Those skilled in the art will appreciate that the invention is not limited to the aforementioned depth-sensing technology, temporal, and/or spatial resolutions. For example, stereo cameras may be used rather than time-of-flight-based cameras.

In one embodiment of the invention, the camera system (102) further includes components that enable communication between a person in the monitored environment and the monitoring system The camera system may thus include a microphone (122) and/or a speaker (124). The microphone (122) and the speaker (124) may be used to support acoustic communication, e.g. verbal communication, as further described below.

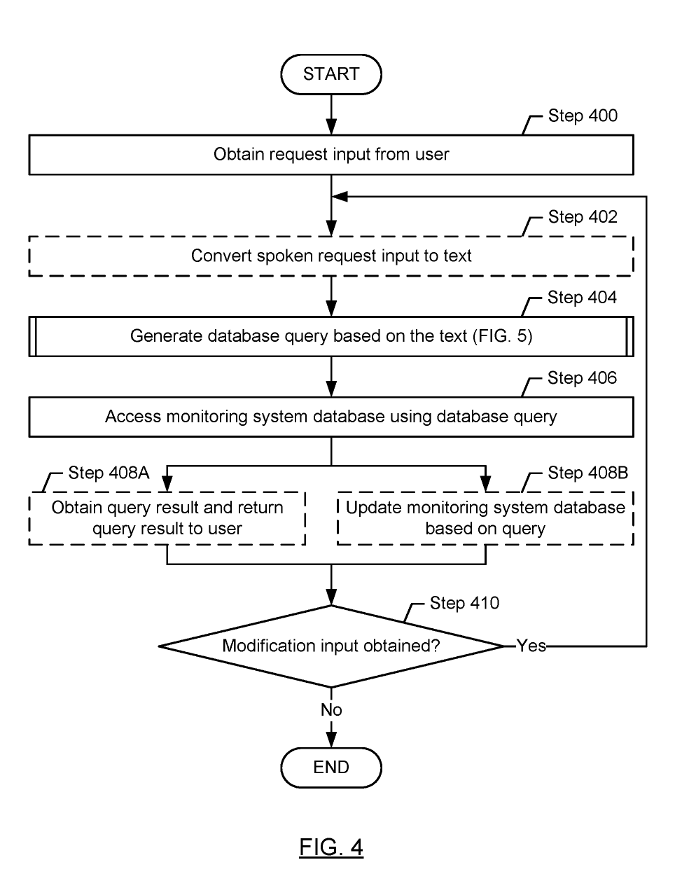

In one embodiment of the invention, the camera system (102) includes a local computing device (110). Any combination of mobile, desktop, server, embedded, or other types of hardware may be used to implement the local computing device. For example, the local computing device (110) may be a system on a chip (SOC), i.e. an integrated circuit (IC) that integrates all components of the local computing device (110) into a single chip. The SOC may include one or more processor cores, associated memory (e.g., random access memory (RAM), cache memory, flash memory, etc.), a network interface (e.g., a local area network (LAN), a wide area network (WAN) such as the Internet, mobile network, or any other type of network) via a network interface connection (not shown), and interfaces to storage devices, input and output devices, etc. The local computing device (110) may further include one or more storage device(s) (e.g., a hard disk, an optical drive such as a compact disk (CD) drive or digital versatile disk (DVD) drive, a flash memory stick, etc.), and numerous other elements and functionalities. In one embodiment of the invention, the computing device includes an operating system (e.g., Linux) that may include functionality to execute the methods further described below. Those skilled in the art will appreciate that the invention is not limited to the aforementioned configuration of the local computing device (110). In one embodiment of the invention, the local computing device (110) may be integrated with the video camera (108) and/or the depth sensing camera (104). Alternatively, the local computing device (110) may be detached from the video camera (108) and/or the depth sensing camera (104), and may be using wired and/or wireless connections to interface with the local computing device (110). In one embodiment of the invention, the local computing device (110) executes methods that include functionality to implement at least portions of the various methods described below (see e.g., FIGS. 4-6). The methods performed by the local computing device (110) may include, but are not limited to, functionality to process and stream video data provided by the camera system (102) to the remote processing service (112), functionality to capture audio signals via the microphone (122), and/or functionality to provide audio output to a person in the vicinity of the camera via the speaker (124).

Continuing with the discussion of FIG. 1, in one or more embodiments of the invention, the monitoring system (100) includes a remote processing service (112). In one embodiment of the invention, the remote processing service (112) is any combination of hardware and software that includes functionality to serve one or more camera systems (102). More specifically, the remote processing service (112) may include one or more servers (each including at least a processor, memory, persistent storage, and a communication interface) executing one or more applications (not shown) that include functionality to implement various methods described below with reference to FIGS. 4-6. The services provided by the remote processing service (112) may include, but are not limited to, functionality for: receiving and archiving streamed video from the camera system (102), monitoring one or more objects in the environment, using the streamed video data, determining whether events have occurred that warrant certain actions, sending notifications to users, analyzing and servicing speech queries, etc.

In one or more embodiment of the invention, the monitoring system (100) includes one or more remote computing devices (114). A remote computing device (114) may be a device (e.g., a personal computer, laptop, smart phone, tablet, etc.) capable of receiving notifications from the remote processing service (112) and/or from the camera system (102). A notification may be, for example, a text message, a phone call, a push notification, etc. In one embodiment of the invention, the remote computing device (114) may include functionality to enable a user of the monitoring system (100) to interact with the camera system (102) and/or the remote processing service (112) as subsequently described below with reference to FIGS. 4-6. The remote computing device (114) may thus accept commands, including voice commands, from a user accessing the remote computing device. A user may, for example, receive a notification when an event is detected, a user may request the visualization of events, etc.

The components of the monitoring system (100), i.e., the camera system(s) (102), the remote processing service (112) and the remote computing device(s) (114) may communicate using any combination of wired and/or wireless communication protocols. In one embodiment of the invention, the camera system(s) (102), the remote processing service (112) and the remote computing device(s) (114) communicate via a wide area network (116) (e.g., over the Internet), and/or a local area network (116) (e.g., an enterprise or home network). The communication between the components of the monitoring system (100) may include any combination of secured (e.g., encrypted) and non-secure (e.g., un-encrypted) communication. The manner in which the components of the monitoring system (100) communicate may vary based on the implementation of the invention.

Additional details regarding the monitoring system and the detection of events that is based on the distinction of foreground objects from the background of the monitored environment are provided in U.S. patent application Ser. No. 14/813,907 filed Jul. 30, 2015, the entire disclosure of which is hereby expressly incorporated by reference herein.

One skilled in the art will recognize that the monitoring system is not limited to the components shown in FIG. 1. For example, a monitoring system in accordance with an embodiment of the invention may not be equipped with a depth-sensing camera. Further, a monitoring system in accordance with an embodiment of the invention may not necessarily require a local computing device and a remote processing service. For example, the camera system may directly stream to a remote processing service, without requiring a local computing device or requiring only a very basic local computing device. In addition, the camera system may include additional components not shown in FIG. 1, e.g. infrared illuminators providing night vision capability, ambient light sensors that may be used by the camera system to detect and accommodate changing lighting situations, etc. Further, a monitoring system may include any number of camera systems, any number of remote processing services, and/or any number of remote computing devices. In addition, the monitoring system may be used to monitor a variety environments, including various indoor and outdoor scenarios.

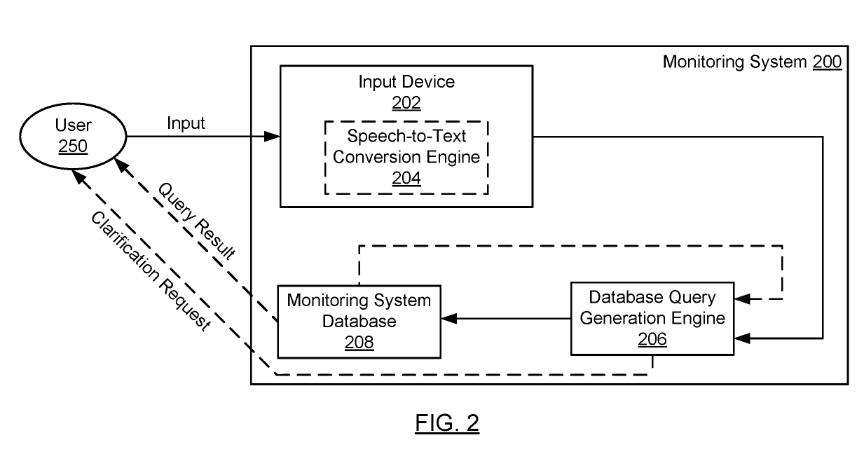

FIG. 2 shows the system components involved in an exemplary interaction of a user with the monitoring system, using spoken language, in accordance with one or more embodiments of the invention. The interaction may result in a response to the user, by the monitoring system, and/or in a change of the configuration of the monitoring system. The interaction may be performed as subsequently described with reference to FIGS. 4-6.

Turning to FIG. 2, a user (250) interacts with the monitoring system (200).

The user (250), in accordance with one or more embodiments of the invention, may be any user of the monitoring system, including but not limited to the owner of the monitoring system, a family member, an administrative user that configures the monitoring system, but also a person that is not affiliated with the monitoring system including, for example, a stranger that is detected in the monitored environment (150) by the monitoring system (200). In one embodiment of the invention, the user (250) directs a request to an input device (202) of the monitoring system (200). The request may be a spoken request or a text request, e.g., a typed text. Accordingly the input device may include the microphone (122) of the camera system (122) or it may include a microphone (not shown) of a remote computing device (114), e.g., of a smartphone, if the request is a spoken request. Alternatively, if the request is a text request, the input device may include a keyboard (not shown) of the remote computing device. The request may also be obtained as a file that includes the recorded audio of a spoken text or typed text. The interaction of the user (250) with the monitoring system may, thus, be local, with the user being in the monitored environment (150), or it may be remote, with the user being anywhere, and being remotely connected to the monitoring system via a remote computing device (114). The request, issued by the user (250), may be any kind of spoken or typed request and may be, e.g., a question or a command. Multiple exemplary user requests are discussed in the subsequently introduced use cases. In one embodiment of the invention, the request is provided using natural, spoken language and therefore does not require the user to be familiar with a particular request syntax. In one embodiment of the invention, the input device (202) captures other audio signals, in addition to the user request. For example, the input device may capture additional interactions with the user, after the user provided an original user request, as further discussed below. Accordingly, the audio signal captured by the input device (202) may be any kind of spoken user input, without departing from the invention.

In one or more embodiments of the invention, the input device further includes a speech-to-text conversion engine (204) that is configured to convert the recorded audio signal, e.g., the spoken user input, to text. The speech-to-text conversion engine (204) may be a software module hosted on either the local computing device (110) of the camera system (102), or on the remote computing device (114), or it may be a component of the remote processing service (112). In one embodiment of the invention, the speech-to-text conversion engine is a cloud service (e.g., a Software as a Service (SaaS), provided by a third party). The speech-to-text-conversion engine may convert the recorded spoken user input to a text in the form of a string.

The text, in one or more embodiments of the invention, is provided to the database query generation engine (206). The database query generation engine (206) may be a software and/or hardware module hosted on either the local computing device (110) of the camera system (102) or on a remote computing device (114). The database query generation engine converts the text into a database query in a format suitable for querying the monitoring system database. The database query generation engine may then analyze the text to extract a message or meaning from the text and generates a database query that reflects the meaning of the text. The database query generation engine may rely on natural language processing methods which may include probabilistic models of word sequences and may be based on, for example, n-gram models. Other natural language processing methods may be used without departing from the invention. Further, the database query generation engine may recognize regular expressions such as, in case of the monitoring system, camera names, user names, dates, times, ranges of dates and times, etc. Those skilled in the art will appreciate that various methods may be used by the database query generation engine to generate a database query based on the text.

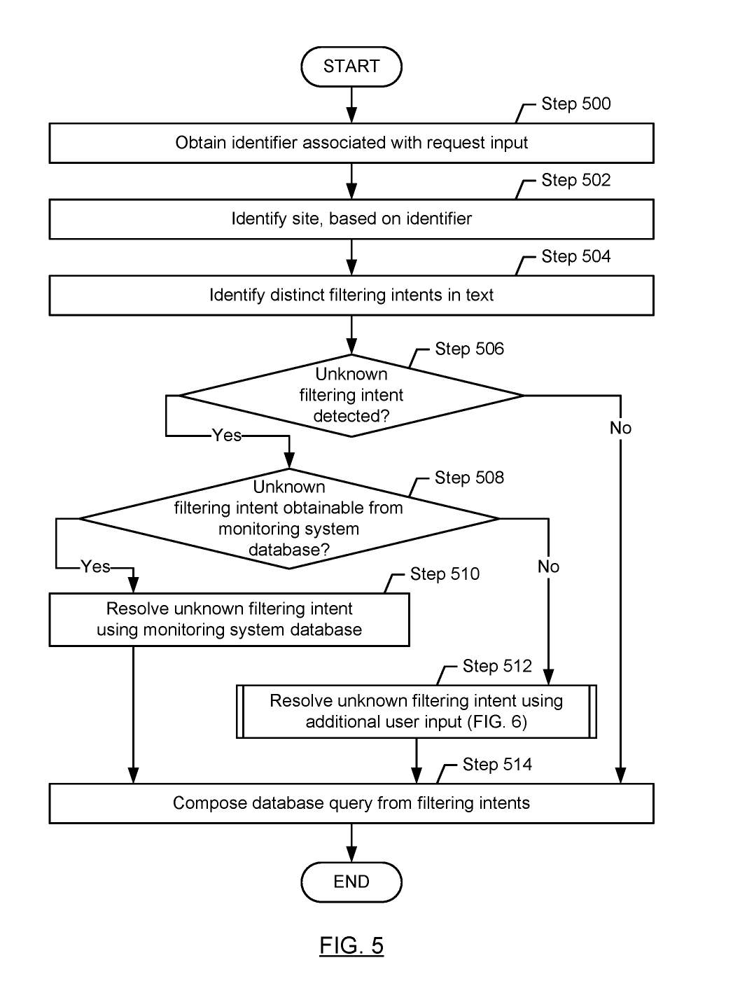

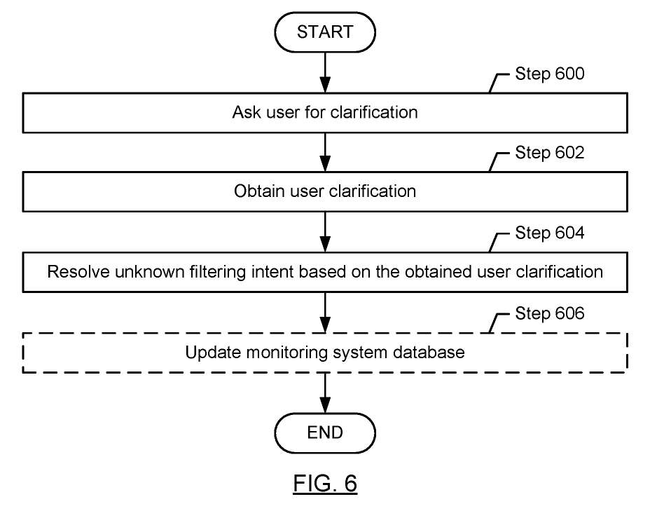

In one embodiment of the invention, the database query generation engine is further configured to resolve texts for which it is initially unable to completely understand all content. This may be the case, for example, if the text includes elements that are ambiguous or unknown to the database query generation engine. In such a scenario, the database query generation engine may attempt to obtain the missing information as supplementary data from the monitoring system database, and/or the database query generation engine may contact the user with a clarification request, enabling the user to provide clarification using spoken language. A description of the obtaining of supplementary data from the monitoring system database (208) and the obtaining of user clarification is provided below with reference to FIGS. 5 and 6.

Continuing with the discussion of the database query generation engine, once a complete database query has been generated, the database query is directed to the monitoring system database. The monitoring system database (208) upon receipt of the database query addresses the query. Addressing the query may include providing a query result to the user and/or updating content of the monitoring system database. The use cases, introduced below, provide illustrative examples of query results returned to the user and of updates of the monitoring system database.

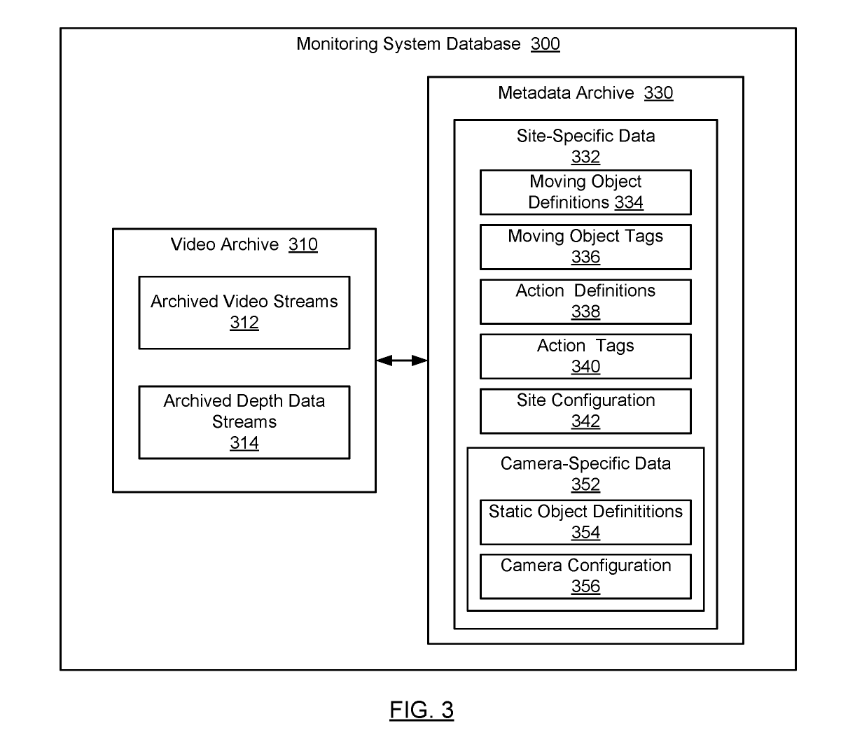

Turning to FIG. 3, FIG. 3 shows an organization of the monitoring system database, in accordance with one or more embodiments of the invention. The monitoring system database may store data received from many monitoring systems. Consider, for example, a monitoring system database that is operated by an alarm monitoring company. Such a monitoring system database may store data for thousands of monitoring systems, installed to protect the premises of customers of the alarm monitoring company. The monitoring system database (300) includes a video archive (310) and a metadata archive (330). The video archive (310) and the metadata archive (330) may be used in conjunction by archiving video data received from the camera system(s) in the video archive (310), and by archiving metadata, serving as a description of the content of the video data, in the metadata archive (330).

In one or more embodiments of the invention, the video data archive (310) stores video data captured by the camera system (102) of the monitoring system (100). The video archive (310) may be implemented using any format suitable for the storage of video data. The video data may be provided by the camera system as a continuous stream of frames, e.g. in the H.264 format, or in any other video format with or without compression. The video data may further be accompanied by depth data and/or audio data. Accordingly, the video archive may include archived video streams (312) and archived depth data streams (314). An archived video stream (312) may be the continuously or non-continuously recorded stream of video frames received from a camera, and that may be stored in any currently available or future video format. Similarly, an archived depth data stream (314) may be the continuously or non-continuously recorded stream of depth data frames received from a depth-sensing camera. The video archive may include multiple video streams and/or audio streams. More specifically, the video archive may include a stream for each camera system installed on a site, such as a house protected by the monitoring system. Consider, for example, a home with two floors. On the first floor, a first camera system that monitors the front door, and a second camera system that monitors the living room are installed. On the second floor, a third camera system that monitors the master bedroom is installed. The site thus includes three camera systems (102), and the video archive (310) includes three separate archived video streams, one for each of the three camera systems. The video archive, as previously noted, may archive video data obtained from many sites.

As video data are received and archived in the video archive (310), tags may be added to label the content of the video streams, as subsequently described. The tags may label objects and/or actions detected in video streams, thus enabling a later retrieval of the video frames in which the object and/or action occurred.

The video archive (310) may be hosted on any type of non-volatile (or persistent) storage, including, for example, a hard disk drive, NAND Flash memory, NOR Flash memory, Magnetic RAM Memory (M-RAM), Spin Torque Magnetic RAM Memory (ST-MRAM), Phase Change Memory (PCM), or any other memory defined as a non-volatile Storage Class Memory (SCM). Further, the video archive (310) may be implemented using a redundant array of independent disks (RAID), network attached storage (NAS), cloud storage, etc. At least some of the content of the video archive may alternatively or in addition be stored in volatile memory, e.g., Dynamic Random-Access Memory (DRAM), Synchronous DRAM, SDR SDRAM, and DDR SDRAM. The storage used for the video archive (310) may be a component of the remote processing service (112), or it may be located elsewhere, e.g., in a dedicated storage array or in a cloud storage service, where the video archive (310) may be stored in logical pools that are decoupled from the underlying physical storage environment.

In one or more embodiments of the invention, the metadata archive (330) stores data that accompanies the data in the video archive (310). Specifically, the metadata archive (330) may include labels for the content stored in the video archive, using tags, and other additional information that is useful or necessary for the understanding and/or retrieval of content stored in the video archive. In one embodiment of the invention, the labels are organized as site-specific data (332) and camera-specific data (342).

The metadata archive (330) may be a document-oriented database or any other type of database that enables the labeling of video frames in the video archive (310). Similar to the video archive (310), the metadata archive (330) may also be hosted on any type of non-volatile (or persistent) storage, in redundant arrays of independent disks, network attached storage, cloud storage, etc. At least some of the content of the metadata archive may alternatively or in addition be stored in volatile memory. The storage used for the metadata archive (310) may be a component of the remote processing service (112), or it may be located elsewhere, e.g., in a dedicated storage array or in a cloud storage service.

The site-specific data (332) may provide definitions and labeling of elements in the archived video streams that are site-specific, but not necessarily camera-specific. For example, referring to the previously introduced home protected by the three camera systems (102), people moving within the house are not camera-specific, as they may appear anywhere in the house. In the example, the owner of the home would be recognized by the monitoring system (100) as a moving object regardless of which camera system (102) sees the owner. Accordingly, the owner is considered a moving object that is site-specific but not camera-specific. As previously noted, the monitoring system database may store data for many sites. The use of site-specific data (332), may enable strict separation of data for different sites. For example, while one site may have a moving object that is the owner of one monitoring system, another site may have a moving object that is considered the owner of another monitoring system. While both owners are considered moving objects, they are distinguishable because they are associated with different sites. Accordingly, there may be a set of site-specific data (332) for each site for which data are stored in the monitoring system database (300).

In one or more embodiments of the invention, frames of the archived video streams in which a moving object is recognized are tagged using site-specific moving object tags (336). Moving object tags (336) may be used to tag frames that include moving objects detected by any camera system of the site, such that the frames can be located, for example for later playback. For example, a user request to show the dog's activity throughout the day may be served by identifying, in the archived video streams (312), the frames that show the dog, as indicated by moving object tags (334) for the dog. Separate moving object tags may be generated, for moving objects including, but not limited to, persons, pets, specific persons, etc., if the monitoring system is capable of distinguishing between these. In other words, site-specific object tags may enable the identification of video and/or depth data frames that include the site-specific moving object. Those skilled in the art will appreciate that any kind of moving object that is detectable by the monitoring system may be tagged. For example if the monitoring system is capable of distinguishing different pets, e.g. cats and dogs, it may use separate tags for cats and dogs, rather than classifying both as pets. Similarly, the monitoring system may be able to distinguish between adults and children and/or the monitoring system may be able to distinguish between different people, e.g. using face recognition. Accordingly, the moving object tags (334) may include person-specific tags.

Moving object tags may be generated as follows. As a video stream is received and archived in the video archive (310), a foreground object detection may be performed. In one embodiment of the invention, a classifier that is trained to distinguish foreground objects (e.g., humans, dogs, cats, etc.) is used to classify the foreground object(s) detected in a video frame. The classification may be performed based on the foreground object appearing in a single frame or based on a foreground object track, i.e., the foreground object appearing in a series of subsequent frames.

The site-specific data (332) of the metadata archive (330) may further include moving object definitions (334). A moving object definition may establish characteristics of the moving object that make the moving object uniquely identifiable. The moving object definition may include, for example, a name of the moving object, e.g., a person's or a pet's name. The moving object definition may further include a definition of those characteristics that are being used by the monitoring system to uniquely identify the moving object. These characteristics may include, but are not limited to, the geometry or shape of the moving object, color, texture, etc., i.e., visual characteristics. A moving object definition may further include other metadata such as the gender of a person, and/or any other descriptive information.

In one or more embodiments of the invention, the moving object definitions (334) may grow over time and may be completed by additional details as they become available. Consider, for example, a person that is newly registered with the site. The monitoring system may initially know only the name of the person. Next, assume that the person's cell phone is registered with the monitoring system, for example, by installing an application associated with the monitoring system on the person's cell phone. The moving object definitions may now include an identifier of the person's cell phone. Once the person visits the site, the monitoring system may recognize the presence of the cell phone, e.g., based on the cell phone with the identifier connecting to a local wireless network or by the cell phone providing location information (e.g., based on global positioning system data or cell phone tower information). If, while the cell phone is present, an unknown person is seen by a camera of the monitoring system, the monitoring system may infer that the unknown person is the person associated with the cell phone, and thus corresponds to the newly registered person. Based on this inferred identity, the monitoring system may store visual characteristics, captured by the camera, under the moving object definition to enable future visual identification of the person. The monitoring system may rely on any of the information stored in the moving object definition to recognize the person. For example, the monitoring system may conclude that the person is present based on the detection of the cell phone, even when the person is not visually detected.

The site-specific data (332) of the metadata archive (330), in one embodiment of the invention, further include action tags (340). Action tags may be used to label particular actions that the monitoring system is capable of recognizing. For example, the monitoring system may be able to recognize a person entering the monitored environment, e.g., through the front door. The corresponding video frames of the videos stored in the video archive may thus be tagged with the recognized action “entering through front door”. Action tags may be used to serve database queries that are directed toward an action. For example, the user may submit the request “Who was visiting today?”, to which the monitoring system may respond by providing a summary video clip that shows all people that were seen entering through the front door. Action tags in combination with moving object tags may enable a targeted retrieval of video frames from the video archive. For example, the combination of the action tag “entering through front door” with the moving object tag “Fred” will only retrieve video frames in which Fred is shown entering through the front door, while not retrieving video frames of other persons entering through the front door.

Action tags may be generated based on foreground object tracks. More specifically, in the subsequent video frames that form the foreground object tracks, motion descriptors such as speed, trajectories, particular movement pattern (e.g., waiving, walking) may be detected. If a particular set of motion descriptors, corresponding to an action, is detected, the video frames that form the foreground object track are tagged with the corresponding action tag.

The site-specific data (332) of the metadata archive (330) may further include action definitions (338). An action definition may establish characteristics of an action that makes the action uniquely identifiable. The action definition may include, for example, a name of the action. In the above example of a person entering through the front door, the action may be named “person entering through front door”. The action definition may further include a definition of those characteristics that are being used by the monitoring system to uniquely identify the action. These characteristics may include, for example, a definition of an object track spanning multiple video frames, that defines the action.

In one embodiment of the invention, the metadata archive (330) further includes a site configuration (342). The site configuration may include the configuration information of the monitoring system. For example, the site configuration may specify accounts for users and administrators of the monitoring system, including credentials (e.g. user names and passwords), privileges and access restrictions. The site configuration may further specify the environments that are being monitored and/or the camera systems being used to monitor these environments.

Continuing with the discussion of the site-specific data (332) of the metadata archive (330), in one embodiment of the invention, camera-specific data (352) include static object definitions (354) and/or a camera configuration (356). Separate static object definitions (354) and camera configurations (356) may exist for each of the camera systems (102) of the monitoring system (100). The camera-specific data (352) may provide labeling of elements in the archived video streams that are camera-specific, i.e., elements that may not be seen by other camera systems. For example, referring to the previously introduced home protected by the three camera systems, the bedroom door is camera-specific, because only the camera system installed in the bedroom can see the bedroom door.

The static objects (354), in accordance with an embodiment of the invention, include objects that are continuously present in the environment monitored by a camera system. Unlike moving objects that may appear and disappear, static objects are thus permanently present and therefore do not need to be tagged in the archived video streams. However, a definition of the static objects may be required, in order to detect interactions of moving objects with these static objects. Consider, for example, a user submitting the question: “Who entered through the front door?” To answer this question, a classification of all non-moving objects as background without further distinction is not sufficient. The camera-specific data (352) therefore include definitions of static objects (354), that enable the monitoring system to detect interactions of moving objects with these static objects. Static objects may thus be defined in the camera-specific data (352), e.g., based on their geometry, location, texture or any other feature that enables the detection of moving objects' interaction with these static objects. Static objects may include, but are not limited to, doors, windows and furniture.

The presence and appearance of static objects in a monitored environment may change under certain circumstances, e.g., when the camera system is moved, or when the lighting in the monitored environment changes. Accordingly, the static object definitions (354) may be updated under these conditions. Further, an entirely new set of static object definitions (354) may be generated if a camera system is relocated to a different room. In such a scenario, the originally defined static objects become meaningless and may therefore be discarded, whereas the relevant static objects in the new monitored environment are captured by a new set of static object definitions (354) in the camera-specific data (352).

Continuing with the discussion of the camera-specific data (352), the camera configuration (356), in accordance with an embodiment of the invention, includes settings and parameters that are specific to a particular camera system (102) of the monitoring system (100). A camera configuration may exist for each camera system of the monitoring system. The camera configuration may include, for example, a name of the camera system, an address of the camera system, a location of the camera system, and/or any other information that is necessary or beneficial for the operation of the monitoring system. Names of camera systems may be selected by the user and may be descriptive. For example, a camera system that is set up to monitor the front door may be named “front door”. Addresses of camera systems may be network addresses to be used to communicate with the camera systems. A camera system address may be, for example, an Internet Protocol (IP) address.

Those skilled in the art will appreciate that the monitoring system database (300) is not limited to the elements shown in FIG. 3. Specifically, the video archive (310) may include any data recorded by any type of sensor of the monitoring system (100), and the metadata archive (330) may include tags and/or definitions for any type of data in the video archive, definitions of the environment(s) being monitored and/or elements therein (such as static objects), and/or definitions of the camera systems or other types of sensors being used for the monitoring. Further, tags may be applied in various ways, without departing from the invention. For example, a tag may be applied by marking a beginning frame and an end frame of an observed object and/or activity to be tagged, or tags may be generated for each individual frame that includes the observed object and/or activity. Alternatively, rather than tagging a frame itself, the time of occurrence of the frame may be recorded. The generation of the tags for the video streams stored in the video archive may be performed in real-time, as the video data are streamed to the video archive, e.g., at the time when objects are detected by the monitoring system, or they may be generated at a later time, by analyzing the stored archived video streams. The tagging may be performed by the local computing device of the camera system, e.g., if the tagging is performed in real-time. If the tagging is performed offline, at a later time, it may be performed by the remote processing service or by any other component that has access to the video archive (310).

FIGS. 4-6 show flowcharts in accordance with one or more embodiments of the invention. While the various steps in the flowcharts are presented and described sequentially, one of ordinary skill will appreciate that some or all of these steps may be executed in different orders, may be combined or omitted, and some or all of the steps may be executed in parallel. In one embodiment of the invention, the steps shown in FIGS. 4-6 may be performed in parallel with any other steps shown in FIGS. 4-6 without departing from the invention.

FIG. 4 shows a method for speech-based interaction with a vision-based monitoring system, in accordance with one or more embodiments of the invention. The interaction may occur locally, e.g., in an environment that is monitored by the monitoring system, or remotely, e.g., via a remote computing device. A user request, in accordance with an embodiment of the invention, may include a question to which the user expects an answer, and/or the user request may include an instruction that the monitoring system is expected to execute.

One or more of the steps described in FIG. 4 may be performed by a local computing device, e.g., a computing device of a camera system, by a remote processing service, or by a combination of a local computing device and a remote processing service.

Turning to FIG. 4, in Step 400, a request input is received from a user. The request input may be a spoken user request, a typed user request, or an otherwise captured request. In case of a spoken user request, the recording may be initiated upon detection of a recording command, e.g., a voice command, a visual command (e.g., a user in the monitored environment performing a particular gesture, a click of a button or of a virtual button on a smartphone, etc.). Alternatively, the recording may be continuously performed.

In Step 402, the recorded spoken user request is converted to text. Any type of currently existing or future speech-to-text conversion method may be employed to obtain a text string that corresponds to the recorded spoken user request. Step 402 is optional and may be skipped, for example, if the request input was provided as a text.

In Step 404, a database query is formulated based on the text. The database query, in accordance with one or more embodiments of the invention, is a representation of the text, in a form that is suitable for querying the monitoring system database. Accordingly, the generation of the database query may be database-specific. The details regarding the generation of the database query are provided below with reference to FIG. 5.

In Step 406, the monitoring system database is accessed using the database query. If the query includes a question to be answered based on content of the monitoring system database, a query result, i.e., an answer to the question, is generated and returned to the user in Step 408A. Consider, for example, a scenario in which a user submits the question “Who was in the living room today?”. The monitoring system database, in this scenario, is queried for any moving object that was identified as a person, during a time span limited to today's date. The querying may be performed by analyzing the moving object tags, previously described in FIG. 2, for detected persons. An additional constraint in the presented scenario is that only persons that were detected in the living room are to be reported. Accordingly, only moving object tags that identify persons being seen by the camera system in the living room, but not by camera systems in other rooms, are considered. The findings are reported to the user, for example, in the form of a summary video that shows the detected persons, or alternatively as a text summary provided as a spoken or written message. The summary video may include at least some of the video frames identified by the identified moving object tags and/or action tags, based on the database query. The video frames may be provided in their original temporal order, in the summary video. Additional video processing may be performed prior to presenting the video to the user. For example, down-sampling may be performed to reduce the length of the video, and/or redundant frames, resulting from the detection of multiple moving objects in the same frames, may be removed. Further, the foreground object that is shown in the video frames, and that the database query is directed to, may be highlighted. For example, the foreground object may be marked by a halo to increase its visibility. The halo may be added to the video frames, thus augmenting the video frames by the remote processing service, such that the summary video transmitted to the remote computing device of the user already includes the halo. Alternatively, the halo may be superimposed on the user's portable device, based on instructions for augmenting the video frames, provided by the remote processing service.

If, alternatively or in addition, the query includes an instruction to update a monitoring system database setting, the monitoring system database is updated in Step 408B. Consider, for example, a scenario in which a user submits the request “Change the camera system's IP address to 192.168.3.66.” The monitoring system database, in this scenario, is accessed to update the IP address setting which may be located in the camera configuration, as previously described in FIG.

2.

In Step 410, a determination is made about whether a modification input was obtained. A modification input may be any kind of input that modifies the original request input. If a determination is made that an a modification input was provided, the method may return to Step 402 in order to process the modification input. Consider, for example, the originally submitted request input “What did Cassie do today?”. As a result, after the execution of Steps 400-408A, the user may receive video frames showing Cassie' s activities throughout the day. In the example, the user then submits the modification input “What about yesterday?”. The modification input is then interpreted in the context of the originally submitted request. In other words, the method of FIG. 4 is subsequently executed for the request input “What did Cassie do yesterday?”.

FIG. 5 shows a method for formulating a database query based on the text obtained by speech-to-text conversion of the spoken user request, in accordance with one or more embodiments of the invention.

Turning to FIG. 5, in Step 500, an identifier, associated with the request input, is obtained. The identifier may enable the monitoring system to resolve the site with which the request input is associated. Determining the correct site is important because a request typically includes site-specific elements. For example, the request “tell Robert that I went grocery shopping” has a different meaning, depending on the site. Specifically, Robert at an exemplary site A may be the husband, whereas at an exemplary site B he may be the son. The identifier may be obtained in various ways. The user's smartphone (or any other remote computing device) may be registered with the monitoring system, and the monitoring system may thus recognize the remote computing device as belonging to the user. The device registration may be stored, for example, in a moving object definition, for the user that owns the device. Any recognizable identifier of the device or software executing on the device may be used to recognize the remote computing device, and subsequently identify the user associated with the remote computing device. For example, a hardware ID, such as a media access control (MAC) address, may be verified. Alternatively or additionally, an authentication key may be provided by the remote computing device. Alternatively, the user may provide credentials such as a user name and/or a password or may provide any other information that enables identification of the user based on information stored about the user in the user's moving object definition. Those skilled in the art will appreciate that any means for identification, suitable for verification against user data stored in the user's moving object definition, may be relied upon, without departing from the invention.

In Step 502, the correct site is identified, based on the identifier. The site to be used in the subsequent steps is the site to which the user belongs. It may be identified, based on the moving object tag that was relied upon to validate the user's identity. For example, if user Jeff in Step 400 issues a user request, and his identity is verified using a moving object tag for a site created for Jeff's condominium, it is the data of this site (Jeff s condominium) that are relied upon in the subsequently discussed steps, whereas data from other sites are not considered.

in Step 504, distinct filtering intents are identified in the text. A distinct filtering intent, in accordance with an embodiment of the invention, may be any kind of content fragment extracted from the text by a text processor. A filtering intent may be obtained, for example, when segmenting the text using an n-gram model. Filtering intents may further be obtained by querying the monitoring system database for regular expressions in the text. Regular expressions may include, but are not limited to, for example, camera names, names of moving and static objects such as names of persons, various types of background elements such as furniture, doors and other background elements that might be of relevance and that were therefore registered as static objects in the monitoring system database. Other regular expressions that may be recognized include user names, dates, times, ranges of dates and times, etc. Filtering intents that were obtained in Step 504 are elements of the text that are considered to be “understood”, i.e., a database query can be formulated based on their meaning, as further described in Step 514. Those skilled in the art will appreciate that a variety of techniques may be employed to obtain filtering intents, including but not limited to, n-gram models, keyword matching, regular expressions, recurrent neural networks, long short term memories, etc.

In the subsequent steps, e.g., Steps 506-512, a validation of the obtained filtering intents is performed. The validation includes determining whether, within the context of the known site, all filtering intents are understood and make sense.

In Step 506, a determination is made about whether the text includes an unknown filtering intent. An unknown filtering intent, in accordance with an embodiment of the invention, is a filtering intent that, after execution of Step 504, remains unresolved, and is therefore “not understood”, thus preventing the generation of a database query. An unknown filtering intent may be, for example, a single word (e.g., an unknown name), a phrase, or an entire sentence. An unknown filtering intent may be a result of the spoken user request including content that, although properly converted to text in Step 402, could not be entirely processed in Step 504. In this scenario, the actual spoken request contained content that could not be resolved. Alternatively, the spoken user request may include only content that could have been entirely processed in Step 504, but an erroneous speech-to-text conversion in Step 402 resulted in a text that included the unknown filtering intent.

If no unknown filtering intent is detected in Step 506, the method may directly proceed to Step 514. If a determination is made that an unknown filtering intent exists, the method may proceed to Step 508.

In Step 508, a determination is made about whether the unknown filtering intent is obtainable from the monitoring system database. In one embodiment of the invention, the monitoring system database may be searched for the unknown filtering intent. In this search, database content beyond the regular expressions already considered in Step 504 may be considered. In one embodiment of the invention, the data considered in step 508 is limited to data specific to the site that was identified in Step 502.

If a determination is made that the monitoring database includes the unknown filtering intent, in Step 510, the unknown filtering intent is resolved using the content of the monitoring system database. Consider, for example the previously discussed user request “Change the camera system's IP address to 192.168.3.66,” and further assume that the entire sentence was correctly converted to text, using the speech-to-text conversion in Step 402. In addition, assume that, in Step 500, the text was segmented into syntactic elements, with only the term “IP address” not having been resolved. In this scenario, in Step 508, the entire monitoring system database is searched, and as a result an “IP address” setting is detected in the camera configuration. The unknown syntactic element “IP address” is thus resolved. Sanity checks may be performed to verify that the resolution is meaningful. In the above example, the sanity check may include determining that the format of the IP address in the user-provided request matches the format of the IP address setting in the monitoring system database. In addition, or alternatively, the user may be asked for confirmation.

Returning to Step 508, if a determination is made that the unknown filtering intent is not obtainable from the monitoring system database, the method may proceed to Step 512, where the unknown filtering intent is resolved based on a user-provided clarification. The details of Step 512 are provided in FIG. 6.

Those skilled in the art will appreciate that above-described Steps 506-512 may be repeated if multiple unknown filtering intents were detected, until all filtering intents are resolved.

In Step 514, the database query is composed based on the filtering intents.

Depending on the user request, the complexity of the database query may vary. For example, a simple database request may be directed to merely retrieving all video frames that are tagged as including a person, seen by the monitoring system. A more complex database query may be directed to retrieving all video frames that include the person, but only for a particular time interval. Another database query may be directed to retrieving all video frames that include the person, when the person performs a particular action. Other database queries may update settings in the database, without retrieving content from the database. In one or more embodiments of the invention, the database query further specifies the site identified in Step 502. A variety of use cases that include various database queries are discussed below. The database query, in one or more embodiments of the invention, is in a format compatible with the organization of the metadata archive of the monitoring system database. Specifically, the database query may be in a format that enables the identification of moving object tags and/or action tags that match the query. Further the query may be in a format that also enables the updating of the metadata archive, including, but not limited to, the moving object definitions, the action definitions, the static object definitions and the camera configuration.

FIG. 6 shows the resolution of an unknown filtering intent using additional user input, in accordance with an embodiment of the invention. In Step 600, the user is asked to provide clarification. The user may be addressed, using e.g. a voice request, via, for example, the speaker of the camera system or of a smartphone. Alternatively, the user may receive a text request, e.g. via the user's smartphone. Consider, for example, a scenario in which the originally submitted user request was “Show me what Lucky was doing in the living room today.” During the execution of the methods described in FIGS. 4 and 5, the formulation of the corresponding database query fails because the filtering intent “Lucky” could not be resolved. Accordingly, the clarification request “Who is Lucky?” may be directed to the user.

In Step 602, a user clarification is obtained. The user clarification may be either a spoken user clarification or a clarification provided via a selection in a video frame.

The spoken user clarification may be obtained, analogous to Step 400 in

FIG. 4. Referring to the above scenario, the clarification may be, for example: “Lucky is the dog.” The spoken user clarification may then converted to text, as described in Step 402 of FIG. 4. Next, filtering intents may be obtained, as described in Step 504 of FIG. 5. Subsequently, in Step 604, the unknown filtering intent may be resolved based on the newly obtained filtering intents. In the above example, an association of the name “Lucky” with the dog that is already stored in the metadata archive of the monitoring system database is established.

The clarification provided via selection in a video frame may be obtained as follows. Consider the user request “Who came through the front door?”, and further assume that the term “front door” is not yet registered as a static object in the metadata archive. Accordingly the term “front door” is an unknown filtering intent. To resolve the unknown filtering intent, the user, in a video frame that shows the front door may select the front door, e.g. by marking the front door using the touchscreen interface of the user's smartphone. The selection of the front door establishes an association of the term “front door” with image content that represents the front door, in the archived video streams, thus resolving the previously unknown filtering intent “front door”.

In Step 606, the monitoring system database may be updated to permanently store the newly resolved filtering intent. In the above examples, the dog's name “Lucky” may be stored in the moving object definition for the dog, and/or the a new static object definition may be generated for the front door. Thus, future queries that include the name “Lucky” and/or the term “front door” can be directly processed without requiring a clarification request.

The use case scenarios described below are intended to provide examples of the user requests that may be processed using the methods described in FIGS. 4-6. The methods, in accordance with one or more embodiments of the invention, are however not limited to these use cases. The use case scenarios described below are based on a household that is equipped with camera systems to monitor various rooms. The household is a condominium owned by Jeff. Accordingly, a site is set up for Jeff's condominium. Assume that the monitoring system has been set up and is configured to recognize Jeff , Lucky the dog, Lucy the cat, and another person that is recognized but whose name has not been shared with the monitoring system. This other person is the dog sitter. The following use cases are based on requests issued by the owner. The use cases are ordered by complexity, with more basic requests being described first.

(i) Owner requests: “Show me what was going on today.” When the user request is received, the monitoring system database is queried to determine that the request was issued by Jeff, and the Jeff is associated with the site “Jeff's condominium”. Accordingly, only data that is associated with the site “Jeff's condominium are considered. The user request, when processed using the previously described methods, is segmented into a syntactic element for a requested activity (“show me”), an unspecific of activity, i.e., any kind of activity (“what was going on”), and a time frame (“today”). Note that even though the syntactic elements convey the message of the request, the actual vocabulary used as syntactic elements may be different, without departing from the invention. Next, a database query is formulated that, when submitted, results in the non-selective retrieval of any activity captured anywhere on site, for the specified time range (“today”). Specifically, the database request, specifies that video frames are to be retrieved from any video stream, regardless of the location of the camera system that provided the video stream, and that the time frame is limited to the interval between midnight and the current time. The retrieval may be performed through identification of all tags in the database that meet these limitations. For example, all moving object tags and all action tags may be considered. Based on these tags, the video frames that these tags refer to are retrieved from the video archive, and a summary video that includes all or at least some of these video frames is generated and returned to the owner.

(ii) Owner asks: “What happened in the living room throughout the day?” This user request, in comparison to request (i) includes an additional constraint. Specifically, only activity that occurred in the living room is to be reported. This additional constraint translates into the database query including a limitation that specifies that only activity captured in the living room is to be considered. Accordingly, only tags for the video stream(s) provided by the camera system installed in the living room are considered. A summary video is thus generated that only includes activity that occurred in the living room, throughout the day.

(iii) Owner asks: “What was the dog doing in the morning?” This user request, unlike the requests (i) and (ii) specifies a particular object of interest (the dog). Accordingly, only tags for the dog are considered. These tags may be moving object tags, with the dog being a specific moving object. Further, the specified time frame is limited to “in the morning”. Accordingly, the database may be queried using a time limitation such as between 12:00 midnight and 12:00 noon, today. A summary video is then generated that only includes video frames in which the dog is present, regardless of the camera that captured the dog, in a time interval between midnight and noon.

(iv) Owner asks: “Was Lucy in the bedroom today?” This user request specifies a name and therefore requires name resolution in order to properly respond to the request. Thus, when formulating the database query the unknown syntactic element “Lucy” is detected. The unknown syntactic element is then resolved using the monitoring system database, based on the association of the name “Lucy” with the moving object “cat”. Based on this association, the syntactic element “Lucy” is no longer unknown, and a complete database query can therefore be submitted. The query may include the term “Lucy” or “cat”, as they are equivalent.

(v) Owner asks: “Did Lucky jump on the couch?” This request not only requires the resolution of the name “Lucky” as described in use case (iv) , but it also requires an interaction of a moving object (Lucky, the dog) with a static object (the couch). Such an interaction, if found in the archived video streams, may be marked using action tags, stored in the metadata archive of the monitoring system database. Accordingly, the database query, in the monitoring system database, triggers are search for action tags that identify the video frames in which the dog was seen jumping onto the couch.

(vi) Owner asks: “When was the dog sitter here?” This user request requires the resolution of the term “dog sitter”. While the dog sitter is a person known to the monitoring system, the term “dog sitter” has not been associated with the recognized person. Accordingly, the monitoring system, whenever the dog sitter appears merely generates tags for the same unknown person. The term “dog sitter” can therefore not be resolved using the monitoring system database. Accordingly, the owner is requested to clarify the term “dog sitter”. The owner, in response, may select, in a video frame or in a sequence of video frames displayed on the owner's smartphone, the unknown person, to indicate that the unknown person is the dog sitter. An association between the detected unknown person and the term “dog sitter” is established and stored in the monitoring system database, thus enabling resolution of requests that include the term “dog sitter”.

(vii) Owner requests: “Change camera location to “Garage”.” This user request involves updating a setting in the monitoring system database. The owner may want to change the camera location, for example, because he decided to move the camera from one room to another room. The update of the camera name is performed by overwriting the current camera location in the camera configuration, stored in the metadata archive. The updated camera location may then be relied upon, for example, when a request is issued that is directed to activity in the garage.

Embodiments of the invention enable the interaction of users with a monitoring system using speech commands and/or requests. Natural spoken language, as if addressing another person, may be used, thus not requiring the memorization and use of a particular syntax when communicating with the monitoring system. The interaction using spoken language may be relied upon for both the regular use and the configuration of the monitoring system. The regular use includes, for example, the review of activity that was captured by the monitoring system. The speech interface, in accordance with one or more embodiments of the invention, simplifies the use and configuration of the monitoring system because a user no longer needs to rely on a complex user interface that would potentially require extensive multi-layer menu structures to accommodate all possible user commands and requests. The speech interface thus increases user-friendliness and dramatically reduces the need for a user to familiarize herself with the user interface of the monitoring system.

Embodiments of the invention are further configured to be interactive, thus requesting clarification if an initial user request is not understood. Because the monitoring system is configured to memorize information learned from a user providing a clarification, the speech interface's ability to handle increasingly sophisticated requests that include previously unknown terminology will continuously develop.

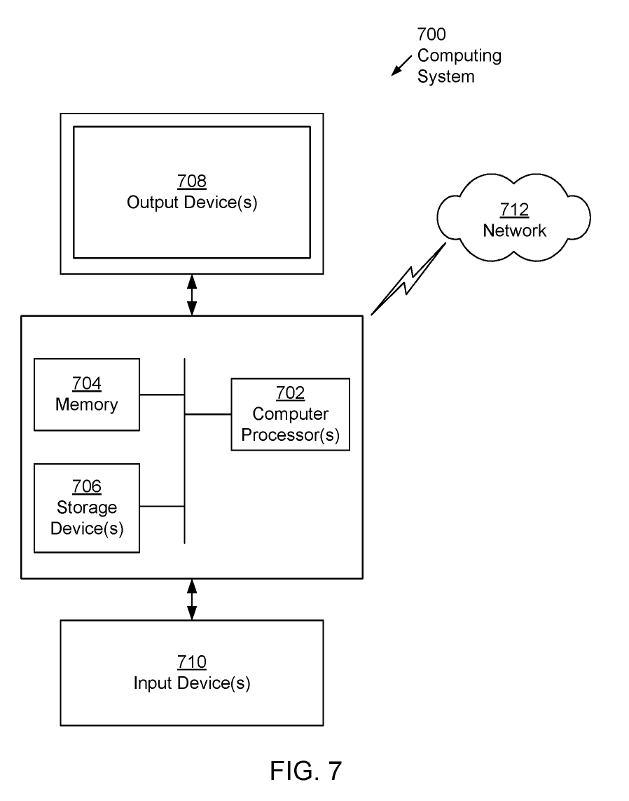

Embodiments of the technology may be implemented on a computing system. Any combination of mobile, desktop, server, embedded, or other types of hardware may be used. For example, as shown in FIG. 7, the computing system (700) may include one or more computer processor(s) (702), associated memory (704) (e.g., random access memory (RAM), cache memory, flash memory, etc.), one or more storage device(s) (706) (e.g., a hard disk, an optical drive such as a compact disk (CD) drive or digital versatile disk (DVD) drive, a flash memory stick, etc.), and numerous other elements and functionalities. The computer processor(s) (702) may be an integrated circuit for processing instructions. For example, the computer processor(s) may be one or more cores, or micro-cores of a processor. The computing system (700) may also include one or more input device(s) (710), such as a touchscreen, keyboard, mouse, microphone, touchpad, electronic pen, or any other type of input device. Further, the computing system (700) may include one or more output device(s) (708), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (700) may be connected to a network (712) (e.g., a local area network (LAN), a wide area network (WAN) such as the Internet, mobile network, or any other type of network) via a network interface connection (not shown). The input and output device(s) may be locally or remotely (e.g., via the network (712)) connected to the computer processor(s) (702), memory (704), and storage device(s) (706). Many different types of computing systems exist, and the aforementioned input and output device(s) may take other forms.

Software instructions in the form of computer readable program code to perform embodiments of the technology may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform embodiments of the technology.

Further, one or more elements of the aforementioned computing system (700) may be located at a remote location and connected to the other elements over a network (712). Further, embodiments of the technology may be implemented on a distributed system having a plurality of nodes, where each portion of the technology may be located on a different node within the distributed system. In one embodiment of the technology, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for natural language-based interaction with a vision-based monitoring system, the method comprising:
obtaining a request input from a user, by the vision-based monitoring system, wherein the request input is directed to a site-specific object detected by a classifier of the vision-based monitoring system and associated with a site-specific identifier;
obtaining the identifier associated with the request input;
identifying a site of the vision-based monitoring system from a plurality of sites, based on the identifier;
generating a database query, based on the request input and the identified site;
obtaining, from a monitoring system database, video frames that relate to the database query, wherein the video frames comprise the detected object; and
providing the video frames to the user.

2. The method of claim 1, wherein the request input comprises text obtained from a user.

3. The method of claim 2, wherein obtaining the text from the user comprises obtaining a spoken user request and converting the spoken user request to text.

4. The method of claim 1, wherein the request input is obtained using a remote computing device that is accessed by the user.

5. The method of claim 1, wherein the identifier comprises one selected from a group consisting of a hardware ID, an authentication key and credentials.

6. The method of claim 1, wherein generating the database query comprises:
identifying, in the request input, a plurality of distinct filtering intents;
validating the plurality of filtering intents; and
composing the database query from the validated plurality of filtering intents.

7. The method of claim 6, wherein validating the plurality of filtering intents comprises:
making a determination that at least one of the plurality of filtering intents is unknown; and
based on the determination:
resolving the unknown filtering intent using site-specific data of the monitoring system database.

8. The method of claim 6, wherein validating the plurality of filtering intents comprises:
making a determination that at least one of the plurality of filtering intents is unknown; and
based on the determination:
submitting a clarification request to the user;
obtaining a user response; and
resolving the unknown filtering intent based on the obtained user response.

9. The method of claim 8, wherein the user response is a spoken clarification, by the user.

10. The method of claim 8, wherein the user response is a selection in a video frame, made by the user.

11. The method of claim 1, wherein obtaining, from the monitoring system database, video frames that relate to the query, comprises:
identifying, in site-specific data of a metadata archive of the monitoring system database, tags that relate to the query,
wherein the tags label occurrences of at least one selected from a group consisting of the object and an action involving the object,
wherein the tags identify the video frames that relate to the query; and
retrieving the video frames that relate to the query from a video archive of the monitoring system.

12. The method of claim 11,
wherein the video frames that relate to the queries are video frames of archived video streams, stored in the video archive, and
wherein the tags of the video frames label content, detected by the vision-based monitoring system.

13. The method of claim 1, further comprising:
receiving a modification input after receiving the request input
modifying, in response to receiving the modification input, the database query to obtain a modified database query;
obtaining, from the monitoring system database, additional video frames that relate to the modified database query; and
providing the additional video frames to the user.

14. The method of claim 1, further comprising, prior to providing the video frames to the user:
augmenting the video frames by adding a halo to highlight the detected object.

15. The method of claim 1, wherein the video frames provided to the user comprise instructions to enable the user's portable device to augment the video frames by adding a halo to highlight the detected object.

16. The method of claim 1, wherein the object detection by the classifier is performed based on the detected object matching information stored in a moving object definition.

17. The method of claim 16, wherein the information stored in the moving object definition comprises at least one selected from a group consisting of visual characteristics of the object and an identifier of the portable computing device associated with the object.

18. A non-transitory computer readable medium comprising instructions that enable a vision-based monitoring system to:
obtain a request input from a user, by the vision-based monitoring system, wherein the request input is directed to a site-specific object detected by a classifier of the vision-based monitoring system and associated with a site-specific identifier;
obtain the identifier associated with the request input;
identify a site of the vision-based monitoring system from a plurality of sites, based on the identifier;
generate a database query, based on the request input and the identified site;
obtain, from a monitoring system database, video frames that relate to the database query, wherein the video frames comprise the detected object; and
provide the video frames to the user.

19. The non-transitory computer readable medium of claim 18, wherein the request input comprises text obtained from a user.

20. The non-transitory computer readable medium of claim 19, wherein obtaining the text from the user comprises obtaining a spoken user request and converting the spoken user request to text.

21. The non-transitory computer readable medium of claim 18, wherein the request input is obtained using a remote computing device that is accessed by the user.

22. The non-transitory computer readable medium of claim 18, wherein the instructions further enable the vision-based monitoring system to, in order to generate the database query:
identify, in the request input, a plurality of distinct filtering intents;
validate the plurality of filtering intents; and
compose the database query from the validated plurality of filtering intents.

23. The non-transitory computer readable medium of claim 22, wherein the instructions further enable the vision-based monitoring system to, in order to validate the plurality of filtering intents comprises:
make a determination that at least one of the plurality of filtering intents is unknown; and
based on the determination:
resolve the unknown filtering intent using site-specific data of the monitoring system database.

24. The non-transitory computer readable medium of claim 22, wherein the instructions further enable the vision-based monitoring system to, in order to validate the plurality of filtering intents:
make a determination that at least one of the plurality of filtering intents is unknown; and
based on the determination:
submit a clarification request to the user;
obtain a user response; and
resolve the unknown filtering intent based on the obtained user response.

25. The non-transitory computer readable medium of claim 23, wherein the user response is a spoken clarification, by the user.

26. The non-transitory computer readable medium of claim 23, wherein the user response is a selection in a video frame, made by the user.

27. The non-transitory computer readable medium of claim 18, wherein the instructions further enable the vision-based monitoring system to, in order to obtain, from the monitoring system database, video frames that relate to the query:
identify, in site-specific data of a metadata archive of the monitoring system database, tags that relate to the query,
wherein the tags label occurrences of at least one selected from a group consisting of the object and an action involving the object,
wherein the tags identify the video frames that relate to the query; and
retrieve the video frames that relate to the query from a video archive of the monitoring system.

28. The non-transitory computer readable medium of claim 27,
wherein the video frames that relate to the queries are video frames of archived video streams, stored in the video archive, and
wherein the tags of the video frames label content, detected by the vision-based monitoring system.

29. The non-transitory computer readable medium of claim 18, wherein the instructions further enable the vision-based monitoring system to, in order to:
receive a modification input after receiving the request input
modify, in response to receiving the modification input, the database query to obtain a modified database query;
obtain, from the monitoring system database, additional video frames that relate to the modified database query; and
provide the additional video frames to the user.

30. The non-transitory computer readable medium of claim 18, wherein the object detection by the classifier is performed based on the detected object matching information stored in a moving object definition.
